(19) United States
(12) Patent Application Publication
(10) Pub. No.: US 2006/0013962 A1
(43) Pub. Date: Jan. 19, 2006

(54) Deposition of high melting temperature and variable resistance metal materials on plastic and metal surfaces using a combination of kinetic and thermal spray processes

(76) Inventors: Brian K. Fuller, Rochester Hills, MI (US); Alaa A. Elmoursi, Troy, MI (US); Thomas Hubert Van Steenkiste, Ray, MI (US); Nilesh B. Patel, Macomb Township, MI (US); John R. Smith, Birmingham, MI (US)

Correspondence Address: SCOTT A. MCBAIN;DELPHI TECHNOLOGIES, INC., Legal Staff, Mail Code: 480-410-202, P.O. Box 5052, Troy, MI, 48007-5052, US

(21) Appl. No.: 10/892,519

(22) Filed: Jul. 15, 2004

(51) Int. Cl. C23C 4/00; B05D 1/08

(52) U.S. Cl. 427/446

(57) ABSTRACT

A method for deposition of a metal layer onto plastic materials is disclosed. The method allows for formation of long length strain gauges and deposition of high melting temperature metals onto plastic materials. The method comprises initially depositing a pattern of powder particles onto the plastic material using a kinetic spray process. Then the high melting temperature metal layer is deposited using a thermal spray process. The metal layer only adheres to the pattern of the powder particles and not to the plastic substrate. To form a stain gauge the powder particles are deposited in a discontinuous non-electrically conductive density on the plastic material. Then a metal layer is deposited using a thermal spray process and a metal having a variable resistance. The metal forms a continuous and electrically conductive pathway having a resistance that changes as stress is applied to the substrate.

### INCORPORATION BY REFERENCE

U.S. Pat. No. 6,139,913, “Kinetic Spray Coating Method and Apparatus,” and U.S. Pat. No. 6,283,386 “Kinetic Spray Coating Apparatus” are incorporated by reference herein.

### TECHNICAL FIELD

The present invention is directed to a method for deposition of high melting temperature and variable resistance metal material onto either metal or plastic surfaces and use of the same to create long length strain gauges.

### RELATED APPLICATIONS

NONE.

### BACKGROUND OF THE INVENTION

At the present time there are no efficient methods for depositing high melting temperature metals onto plastics. The plastic materials of interest can be formed objects or surfaces formed from a plastic or a plastic layer over a metal substrate. Thermal spray processes are commonly used to deposit high melting temperature metals onto other metals, however they have been unable to deposit these metals onto plastics. The metals do not adhere to the plastics and cause physical and thermal damage to the plastics. To date methods have included bonding a metal surface to the plastic material and then applying the metal layer to the bonded surface using thermal spray. Alternatively, a series of steadily increasing melting temperature metals are deposited as a series of layers to eventually achieve a high melting temperature metal layer on the plastic material.

Another difficulty is detecting stress in structural beams, pipes and conduits, especially if they are buried or covered by other building materials. At the present time there are no satisfactory methods for detecting such stresses so repairs can be accomplished readily.

It would be advantageous to develop a simple and rapid method for depositing high melting temperature metals onto plastic materials. In addition, it would be advantageous to develop long length strain gauges to detect stresses in covered materials to allow for easier repair.

### SUMMARY OF THE INVENTION

In one embodiment, the present invention is a method of forming a strain gauge on a metal surface comprising the steps of: applying an electrically insulative layer to a metal surface; kinetically spraying a discontinuous non-electrically conductive pattern of powder particles onto the electrically insulative layer, the particles adhering to the insulative layer and a majority of the particles partially protruding there from; and thermally spraying an electrically conductive metal layer having a variable resistance onto the pattern of powder particles, the metal layer only adhering to the powder particle pattern and the resistance of the metal layer varying as a function of stress in the metal surface.

In another embodiment, the present invention is a method of forming a strain gauge on a plastic material surface comprising the steps of: kinetically spraying a discontinuous non-electrically conductive pattern of powder particles onto a surface of a plastic material, the particles adhering to the surface and a majority of the particles partially protruding there from; and thermally spraying an electrically conductive metal layer having a variable resistance onto the pattern of powder particles, the metal layer only adhering to the pattern of powder particles and the resistance of the metal layer varying as a function of stress in the plastic material surface.

In another embodiment the present invention is a method of forming strain gauge on a plastic material surface comprising the steps of: applying a discontinuous non-electrically conductive pattern of powder particles onto a surface of a plastic material and applying a compressive force to the pattern of particles, the particles adhering to the surface and a majority of the particles partially protruding there from; and thermally spraying an electrically conductive metal layer having a variable resistance onto the pattern of powder particles, the metal layer only adhering to the pattern of the powder particles and the resistance of the metal layer varying as a function of stress in the plastic material surface.

In another embodiment, the present invention is a method of forming a high melting temperature metal layer on a plastic material surface comprising the steps of: kinetically spraying a pattern of powder particles onto a surface of a plastic material, the particles adhering to the surface and a majority of the particles partially protruding there from; and thermally spraying a high melting temperature metal layer onto the pattern of powder particles, the metal layer only adhering to the pattern of powder particles in the plastic material surface and having a melting temperature of at least 400° F.

In another embodiment, the present invention is a method of forming a high melting temperature metal layer on a plastic material surface comprising the steps of: applying a pattern of powder particles onto a surface of a plastic material and applying a compressive force to the pattern of particles, the particles adhering to the surface and a majority of the particles partially protruding there from; and thermally spraying a high melting temperature metal layer onto the pattern of powder particles, the metal layer only adhering to the pattern of powder particles in the plastic material surface and having a melting temperature of at least 400° F.

In another embodiment, the present invention comprises a method of forming a long length strain gauge comprising the steps of: providing an electrically insulative layer on a surface the surface comprising one of a ceramic surface, a metal surface, or a mixture thereof; kinetically spraying a continuous, electrically conductive layer of powder particles onto the electrically insulative layer, the particles adhering to the insulative layer and a majority of the particles partially protruding there from and the electrical resistance of the powder particles layer varying as a function of stress in the surface.

In another embodiment, the present invention comprises a method of forming a strain gauge on a plastic material surface comprising the steps of: kinetically spraying a continuous electrically conductive pattern of powder particles onto a surface of a plastic material, the particles adhering to the surface and a majority of the particles partially protruding there from and the electrical resistance of the powder particles layer varying as a function of stress in the plastic material surface.

### BRIEF DESCRIPTION OF THE DRAWINGS

FIG. 1 is a schematic diagram of a kinetic spray system according to the present invention;

FIG. 2 is a cross-sectional view of one embodiment of a supersonic nozzle for use in the kinetic spray system of FIG. 1;

FIG. 3 is a cross-sectional view of another embodiment of a supersonic nozzle for use in the kinetic spray system of FIG. 1;

FIG. 4 is a schematic diagram illustrating deposition of powder particles onto a plastic material according to the present invention;

FIG. 5 is a schematic diagram of one embodiment of the present invention;

FIG. 6 is a schematic diagram of another embodiment of the present invention;

FIG. 7 is a photomicrograph of a lexan sheet coated according to the present invention;

FIG. 8 is a photomicrograph of a lexan sheet coated according to the present invention;

FIG. 9 is a schematic diagram of a device for testing the electrical resistance as a function of applied stress of a coating prepared according to the present invention; and

FIG. 10 is a graph illustrating the results of a series of tests conducted using a coating prepared according to the present invention and the device shown in FIG. 9.

### DESCRIPTION OF A PREFERRED EMBODIMENT

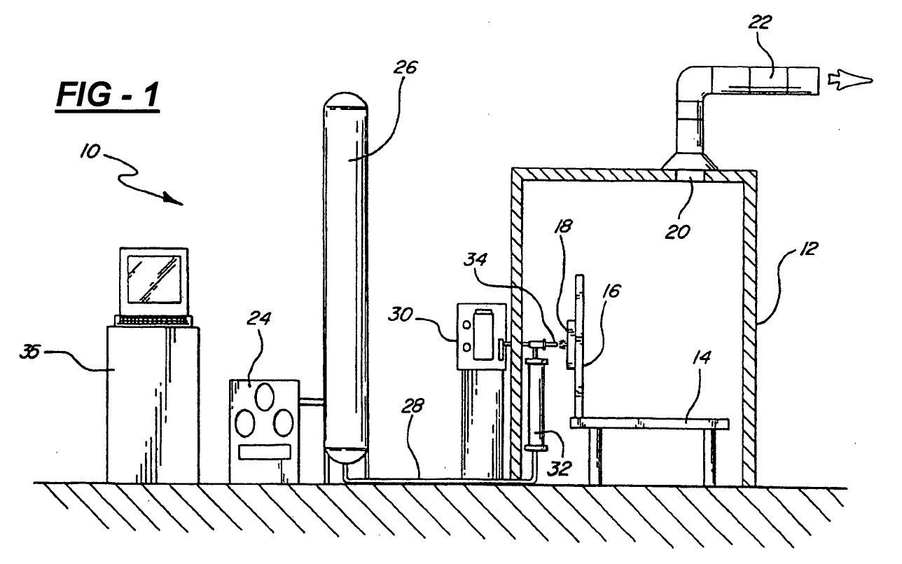

Referring first to FIG. 1, a kinetic spray system according to the present invention is generally shown at 10. System 10 includes an enclosure 12 in which a support table 14 or other support means is located. A mounting panel 16 fixed to the table 14 supports a work holder 18 capable of movement in three dimensions and able to support a suitable workpiece formed of a substrate material to be coated. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes a gas compressor 24 capable of supplying gas pressure up to 3.4 MPa (500 psi) to a high pressure gas ballast tank 26. The gas ballast tank 26 is connected through a line 28 to powder feeder 30 and a separate gas heater 32. The powder feeder 30 can either be a high pressure powder feeder or a low pressure feeder as described below. The gas heater 32 supplies high pressure heated gas, the main gas described below, to a kinetic spray nozzle 34. It is possible to provide the nozzle 34 with movement capacity in three directions in addition to or rather than the work holder 18. The pressure of the main gas generally is set at from 150 to 500 psi. The powder feeder 30 mixes particles of a spray powder with the gas at a desired pressure and supplies the mixture of particles to the nozzle 34. A computer control 35 operates to control both the pressure of gas supplied to the gas heater 32 and the temperature of the heated main gas exiting the gas heater 32. Useful gases include air, nitrogen, helium and others.

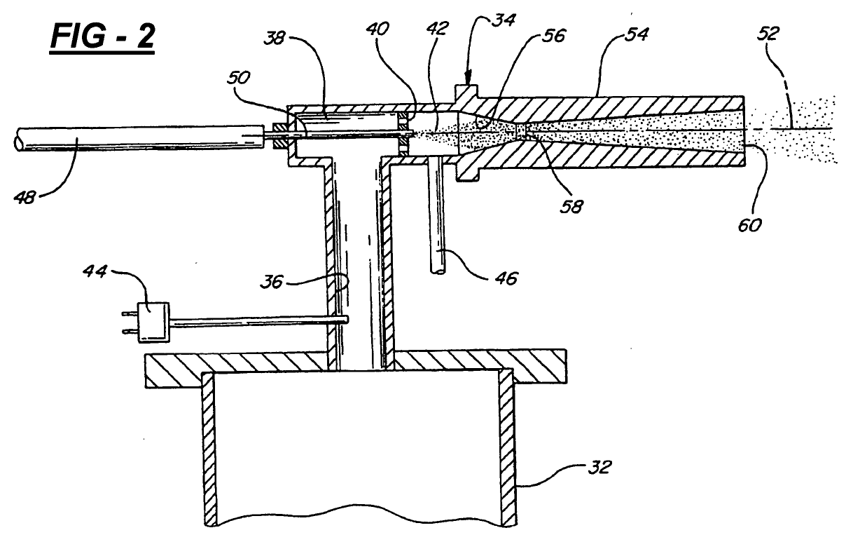

FIG. 2 is a cross-sectional view of one embodiment of the nozzle 34 and its connections to the gas heater 32 and a high pressure powder feeder 30. A main gas passage 36 connects the gas heater 32 to the nozzle 34. Passage 36 connects with a premix chamber 38 that directs the main gas through a flow straightener 40 and into a chamber 42. Temperature and pressure of the heated main gas are monitored by a gas inlet temperature thermocouple 44 in the passage 36 and a pressure sensor 46 connected to the chamber 42. The main gas has a temperature that is always insufficient to cause melting in the nozzle 34 of any particles being sprayed. The main gas temperature can range from 200 to 3000° F. The main gas temperature can be well above the melt temperature of the particles. Main gas temperatures that are 5 to 7 fold above the melt temperature of the particles have been used in the present system 10. What is necessary is that the temperature and exposure time to the main gas be selected such that the particles do not melt in the nozzle 34. The temperature of the gas rapidly falls as it travels through the nozzle 34. In fact, the temperature of the gas measured as it exits the nozzle 34 is often at or below room temperature even when its initial temperature is above 1000° F.

Chamber 42 is in communication with a de Laval type supersonic nozzle 54. The nozzle 54 has a central axis 52 and an entrance cone 56 that decreases in diameter to a throat 58. The entrance cone 56 forms the converging region of the nozzle 54. Downstream of the throat 58 is an exit end 60 and a diverging region is defined between the throat 58 and the exit end 60. The largest diameter of the entrance cone 56 may range from 10 to 6 millimeters, with 7.5 millimeters being preferred. The entrance cone 56 narrows to the throat 58. The throat 58 may have a diameter of from 3.5 to 1.5 millimeters, with from 3 to 2 millimeters being preferred. The diverging region of the nozzle 54 from downstream of the throat 58 to the exit end 60 may have a variety of shapes, but in a preferred embodiment it has a rectangular cross-sectional shape. At the exit end 60 the nozzle 54 preferably has a rectangular shape with a long dimension of from 8 to 14 millimeters by a short dimension of from 2 to 6 millimeters. The diverging region can have a length of from about 100 millimeters to about 400 millimeters.

In this embodiment the injector tube 50 is aligned with the central axis 52. An inner diameter of the injector tube 50 can vary between 0.4 to 3.0 millimeters. The nozzle 54 produces an exit velocity of the entrained particles of from 300 meters per second to as high as 1200 meters per second. The entrained particles gain kinetic and thermal energy during their flow through this nozzle 54. It will be recognized by those of skill in the art that the temperature of the particles in the gas stream will vary depending on the particle size and the main gas temperature. The main gas temperature is defined as the temperature of heated high-pressure gas at the inlet to the nozzle 54. Since these temperatures are chosen so that they heat the particles to a temperature that is less than the melting temperature of the particles, even upon impact, there is no change in the solid phase of the original particles due to transfer of kinetic and thermal energy, and therefore no change in their original physical properties. The particles themselves are always at a temperature below their melt temperature. The particles exiting the nozzle 54 are directed toward a surface of a substrate to coat it.

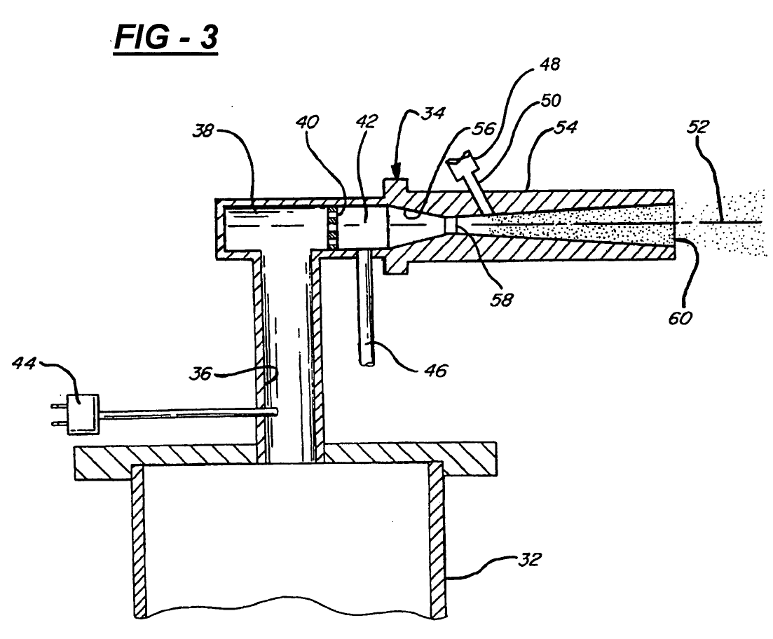

FIG. 3 is a cross-sectional view of another embodiment of the nozzle 34 and its connections to the gas heater 32 and a low pressure powder feeder 30. This nozzle 34 differs from that in FIG. 2 in two ways. First, it is connected to a low pressure powder feeder 30 rather than a high pressure one. Second, the supplement inlet line 48 connects to an injector tube 50 that supplies the particles to the nozzle 54 in the diverging region downstream from the throat 58, which is a region of reduced main gas pressure. The main gas passage 36 connects the gas heater 32 to the nozzle 34. Passage 36 connects with a premix chamber 38 that directs the main gas through a flow straightener 40 and into a chamber 42. Temperature and pressure of the heated main gas are monitored by the gas inlet temperature thermocouple 44 in the passage 36 and the pressure sensor 46 connected to the chamber 42. The main gas has a temperature that is always insufficient to cause melting in the nozzle 34 of any particles being sprayed. The main gas temperature can range from 200 to 3000° F. The main gas temperature can be well above the melt temperature of the particles. Main gas temperatures that are 5 to 7 fold above the melt temperature of the particles have been used in the present system 10. What is necessary is that the temperature and exposure time to the main gas be selected such that the particles do not melt in the nozzle 34. The temperature of the gas rapidly falls as it travels through the nozzle 34. In fact, the temperature of the gas measured as it exits the nozzle 34 is often at or below room temperature even when its initial temperature is above 1000° F.

Chamber 42 is in communication with the de Laval type supersonic nozzle 54. The nozzle 54 has a central axis 52 and an entrance cone 56 that decreases in diameter to a throat 58. The entrance cone 56 forms the converging region of the nozzle 54. Downstream of the throat 58 is the exit end 60 and a diverging region is defined between the throat 58 and the exit end 60. The largest diameter of the entrance cone 56 may range from 10 to 6 millimeters, with 7.5 millimeters being preferred. The entrance cone 56 narrows to the throat 58. The throat 58 may have a diameter of from 3.5 to 1.5 millimeters, with from 3 to 2 millimeters being preferred. The diverging region of the nozzle 54 from downstream of the throat 58 to the exit end 60 may have a variety of shapes, but in a preferred embodiment it has a rectangular cross-sectional shape. At the exit end 60 the nozzle 54 preferably has a rectangular shape with a long dimension of from 8 to 14 millimeters by a short dimension of from 2 to 6 millimeters.

The angle of the injector tube 50 relative to the central axis 52 can be any that ensures that the particles are directed toward the exit end 60, basically from 1 to about 90 degrees. It has been found that an angle of 45 degrees relative to central axis 52 works well. An inner diameter of the injector tube 50 can vary between 0.4 to 3.0 millimeters.

Using a nozzle 54 as shown in FIG. 3 having a length of 300 millimeters from throat 58 to exit end 60, a throat of 2 millimeters and an exit end 60 with a rectangular opening of 5 by 12.5 millimeters the pressure drops quickly as one goes downstream from the throat 58. The measured pressures were: 14.5 psi at 1 inch after the throat 58; 20 psi at 2 inches from the throat 58; 12.8 psi at 3 inches from the throat 58; 9.25 psi at 4 inches from the throat 58; 10 psi at 5 inches from the throat 58 and below atmospheric pressure beyond 6 inches from the throat 58. The rate at which the main gas pressure decreases is a function of the cross-sectional area of the throat 58 and the cross-sectional area of the diverging region at the point of injection. With a larger throat 58 and the same cross-sectional area of the diverging region the main gas pressure stays above atmospheric for a longer distance. What is necessary is that the powder particles be injected at a point located between the throat 58 and the position in the diverging region where the main gas pressure is at atmospheric pressure so one always uses a positive pressure in the powder feeder 30. This embodiment allows one to use much lower pressures to inject the powder when the injection takes place after the throat 58. The low pressure powder feeder 30 of the present invention has a cost that is approximately ten-fold lower than the high pressure powder feeder used with the nozzle 34 of FIG. 2. Generally, the low pressure powder feeder 30 is used at a pressure of 100 psi to 5 psi. All that is required is that it exceeds the main gas pressure at the point of injection and that the main gas pressure be above atmospheric.

The nozzle 54 produces an exit velocity of the entrained particles of from 300 meters per second to as high as 1200 meters per second. The entrained particles gain kinetic and thermal energy during their flow through this nozzle 54. It will be recognized by those of skill in the art that the temperature of the particles in the gas stream will vary depending on the particle size and the main gas temperature. The main gas temperature is defined as the temperature of heated high-pressure gas at the inlet to the nozzle 54. Since these temperatures are chosen so that they heat the particles to a temperature that is less than the melting temperature of the particles, even upon impact, there is no change in the solid phase of the original particles due to transfer of kinetic and thermal energy, and therefore no change in their original physical properties. The particles themselves are always at a temperature below their melt temperature. The particles exiting the nozzle 54 are directed toward a surface of a substrate to coat it.

The powder particles used for kinetic spraying in accordance with the present invention generally comprise metals, alloys, ceramics, diamonds and mixtures of these particles. The particles may have an average nominal diameter of from greater than 50 microns to about 200 microns. Preferably the particles have an average nominal diameter of from 50 to 180 microns.

Preferably the main gas pressure using either embodiment of the nozzle 34 is set at from 200 to 400 psi and the main gas temperature is preferably from 200 to 3000° F. Preferably when using the nozzle 34 shown in FIG. 2 the pressure of gas used in the high pressure powder feeder 30 is from 25 to 75 psi above the main gas pressure as measured at the pressure sensor 46. The stand off distance between the exit end 60 and the substrate is preferably from 0.5 to 12 inches, more preferably from 0.5 to 7 inches and most preferably from 0.5 to 3 inches. The traverse rate of the nozzle 34 and the substrate relative to each other is preferably from 25 to 2500 millimeters per second, more preferably from 25 to 250 millimeters per second, and most preferably from 50 to 150 millimeters per second. Preferably the powder particles are feed to the nozzle 34 at a rate of from about 10 to 60 grams per minute. The preferred particle velocities range from about 300 to 1200 meters per second.

In the present invention the kinetic spray process as described above is used in combination with thermal spray technology to coat materials with high temperature metals or ceramics that are difficult or impossible to coat using thermal spray technology alone. Thermal spray systems are well know in the art and will not be described in detail. The key difference between thermal spray and kinetic spray is that in all thermal spray systems the particles emerge from the thermal spray system in a molten state prior to striking a substrate. Upon striking the substrate these molten particles splat as they strike the substrate and stick under the proper conditions. One of the drawbacks with thermal spray technology has been the inability to use it to coat plastic materials with high melting temperature metals or ceramics. The reason is that the molten particles damage the plastic material and generally do not adhere. As used in the present specification and claims a plastic material is broadly defined as polymers that can be formed or molded under heat or pressure and may be either a thermosetting plastic or a thermoforming plastic. Such materials include, but are not limited to: fluorocarbon resins, nylons, phenolics, polyimides, silicones, cellulosics, polyethylenes, polypropylenes, polybutylenes, polyarcrylics, polymethacrylics, polystyrenes, polyurethanes, acetals, polycarbonates, acrylonitrile-butadiene-styrenes, polyvinychlorides, epoxies, and terephthalates.

A significant advantage of the present invention is that the thermally sprayed metals will only stick to the kinetically sprayed particles that adhere to the substrate and not directly to the substrates of interest, thus one does not require a mask or extensive post coating modifications. This is important because applying masking materials can be a costly process. Use of the present invention allows one to coat plastic materials with high melting temperature metals or ceramics that have melting temperatures of 400° F. or greater. For the present invention twin wire arc thermal spray processes are especially useful, although other thermal spray processes such as plasma thermal spray, flame spray and high velocity oxy-fuel spray can be used. These high melting temperature materials can also be used to form long length strain gauges as described below.

FIG. 4 is a schematic diagram showing deposition of powder particles onto a plastic material by a kinetic spray process. The plastic material substrate is shown at 100. The particles 102 were kinetically sprayed at too high of a particle velocity and thus most penetrated through a surface 104 of the plastics material 100, this is not according to the present invention. The particles 106 were kinetically sprayed at too low of a particle velocity and the majority do not adhere to the plastics material 100. The particles 108 were kinetically sprayed according to the present invention and show the proper penetration and adherence to the surface 104. The particles 108 penetrate the plastic material 100 sufficiently to adhere while still protruding from the surface 104. Importantly, the particles 108 do not penetrate all the way through the plastic material 100, but only partially so a good portion of the particle 108 remains above the surface 104. The required particle velocity is determined by the material of the particle powder, their average nominal diameter, and the hardness of the plastic material.

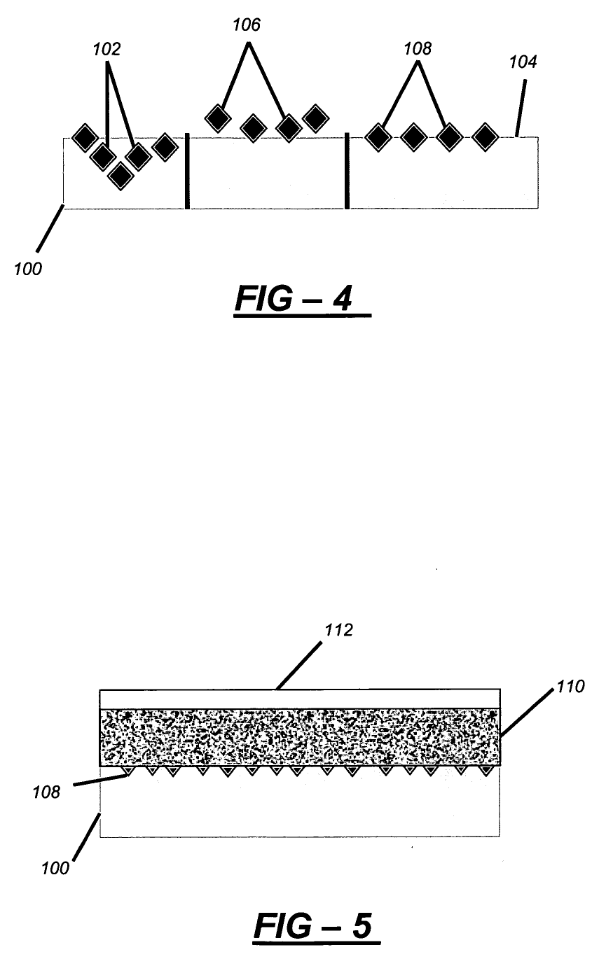

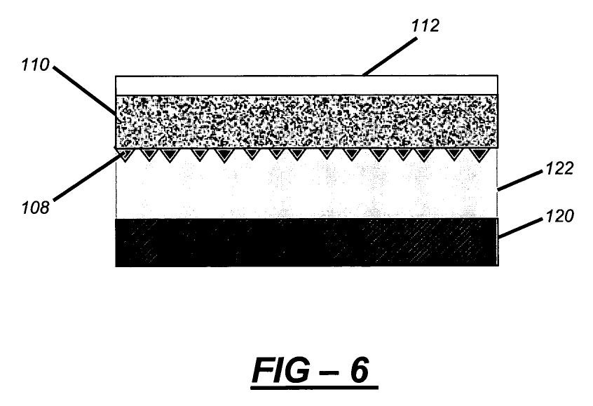

FIG. 5 is a schematic diagram of one embodiment of the present invention. In this embodiment a plastic material 100 has been initially coated with powder particles 108 by a kinetic spray process. Then a twin wire arc thermal spray system is used to apply a high melting temperature metal or ceramic layer 110. The layer 110 can comprise a metal, an alloy, a ceramic or mixtures thereof. An optional final layer is an outer protective layer 112. The outer protective layer can also be a plastic material, insulation or other coating.

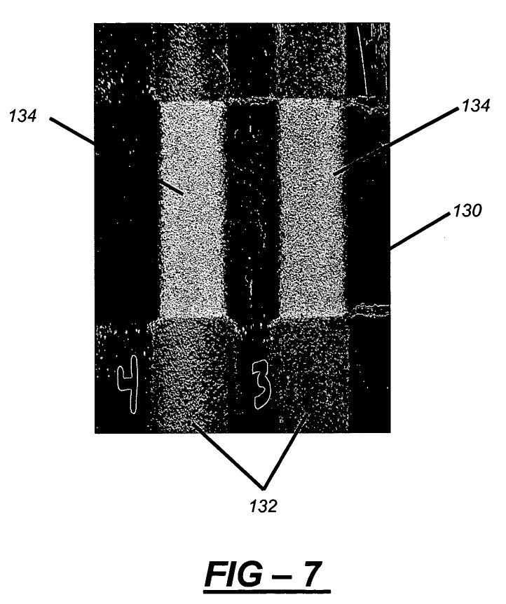

FIG. 6 is a schematic diagram of another embodiment of the present invention. In this embodiment a surface 120 comprising a metal or a ceramic material is initially coated with an insulative layer 122, which may be a plastic material. Then powder particles 108 are deposited using a kinetic spray process. After the kinetic spray process the powder particles 108 are covered with a high melting temperature metal or ceramic layer 110 via a thermal spray process. Finally, an optional layer is an outer protective layer 112.

The two embodiments shown in FIGS. 5 and 6 are meant to generally illustrate the invention. The surface 120 can be formed from a metal, an alloy, a ceramic, or a surface that is a mixture of these. The insulative layer 122 is preferably an electrically insulative layer formed from a plastic material or a ceramic such as a plasma thermal spray applied layer of alumina. The invention finds at least two principal uses: as a method of creating long length strain gauges; and as a method for coating plastics with high melting temperature metals or ceramics.

In one embodiment the invention can be used to form long length strain gauges that can be use to monitor stress in surfaces. By selecting as the material for the layer 110 a metal that has a variable electrical resistance a strain gauge can be created. In this use the plastic material 100 or the electrically insulative layer 122 is first coated with powder particles 108 by a kinetic pray process, examples below. The kinetic spray parameters are adjusted to provide for a discontinuous non-electrically conducting distribution of the powder particles 108 onto the plastic material 100 or the insulative layer 122. The kinetic spray process can spray lines that have a width of as little as 2 millimeters. Then a thermal spray process, preferably twin wire arc, is used to deposit a metal layer 110 using a metal that has a variable electrical resistance onto the powder particles 108. Examples of these metals include copper, copper alloys, nickel chrome alloys and others. A unique feature of the present invention is that the thermally sprayed particles only adhere where the powder particles 108 have been deposited. The thermally sprayed metal layer 110 will not adhere to bare plastic material 100 or the bare insulative layer 122. This eliminates the need for masking. As shown below, stress in the plastic material 100 or the metal surface 120 caused by bending can lead to a measurable change in the electrical resistance and electrical conductance of the thermal sprayed metal layer 110 and can be correlated with a stress value. Thus by continuously or periodically measuring the conductance or resistance of the layer 110 one can detect stress in the plastic material 100 or layer 120. This can find special use in very long length strain gauges such as for pipes, conduits, structural beams, support structures and other metal or ceramic surfaces 120 and plastic materials 100. When used on pipes, for example, it can be used to detect stress over long distances of 50 feet or more even if the pipe is buried. On structural beams it can be used to detect stress in buildings and bridges and other structures. As can be seen irrespective of whether the surface is a plastic material 100 or a metal or a ceramic layer 120 the present invention can be used to create unique long length strain gauges. Preferably, when coating pipes or beams the kinetic spray pattern and thermal spray pattern is helical around the pipe or beam.

As an alternative to kinetic spray applying the powder particles 108 one can also deposit the powder particles 108 onto the plastic material 100 or the insulative layer 122 in the desired pattern and then subject it to compressive force of from about 2000 to 5000 pounds. The particles 108 then adhere to the plastic material 100 or insulative layer 122 and can then be coated with the metal layer 110. It can be advantageous to pre-heat the plastic material 100 or insulative layer 122 prior to application of the powder particles 108. Again the thermally sprayed metal layer 110 only adheres to the pattern of the powder particles 108.

A third method for creating a long length strain gauge is to increase the density of the kinetically sprayed powder particle 108 deposit until it is continuous and electrically conductive and to use a powder particle 108 material that has a variable electrical resistance. In this embodiment there is no need for a second thermally sprayed layer. One begins with a plastic material 100 or an insulative layer 122 on a metal or a ceramic and then applies powder particles 108 using a metal, an alloy, or a mixture thereof onto the plastic material 100 or insulative layer 122. The density can be increased by slowing the transverse rate, increasing the powder feed rate, or increasing the number of deposit passes.

In a second embodiment of the present invention it can be used to deposit high melting temperature metals or ceramics onto plastic materials 100 or insulative layers 122. The same deposition techniques described above can be used for the powder particles 108, namely either kinetic spray or compression. The difference is that the powder particle 108 layer does not necessarily need to be discontinuous and electrically non-conductive, but it can be. Then the layer 110 of metal or ceramic or a mixture thereof is deposited using a thermal spray process. Preferably the process is used to deposit metals or ceramics having melting temperatures of 400° F. or greater. Such deposits using thermal spray were not previously obtainable on plastic materials or insulative layers.

These deposited metal layers 110 can be used to form heating elements by connecting the metal layer 110 to an electrical source. Examples included forming a heated steering wheel, by coating a plastic wheel shell with copper by a kinetic spray process and then covering this with nickel chrome using a thermal spray process. This allows for a heated steering wheel. Similarly a plastic panel can be coated with copper using a kinetic spray process followed by a deposit of nickel chrome using a thermal spray process to form a heater panel.

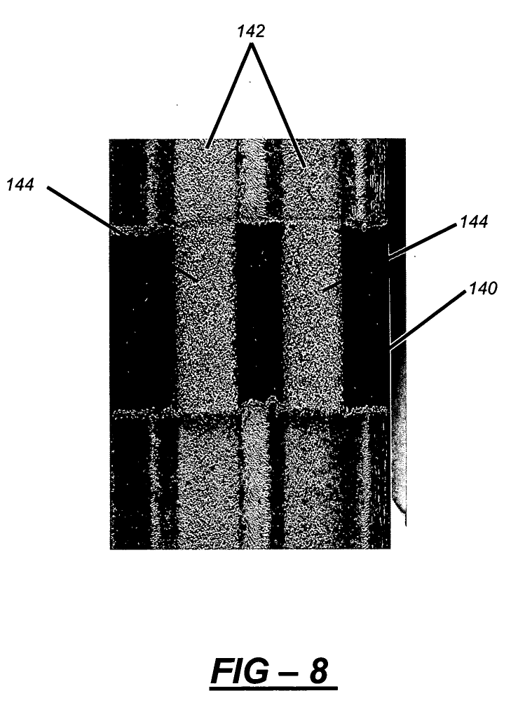

FIG. 7 is a photomicrograph showing an example of the present invention. A lexan plastic material 130 was initially sprayed with copper by a thermal spray process using a nozzle 34 like that shown in FIG. 2. The kinetic spray parameters were as follows: a main gas pressure of 300 psi, powder particle gas pressure of 350 psi, main gas temperature of 800° F., traverse speed 100 millimeters per second, powder feed rate of 12 grams per minute, powder particle nominal average diameter of from greater than 50 to 106 microns, and a stand off distance of 1 inch. The deposited copper powder particles 132 formed a discontinuous non-conducting pathway on the lexan 130 with well defined edges. The twin wire arc thermal spray was used to deposit a metal layer 134 over the powder particles 132. The twin wire arc parameters were as follows: nickel chrome wires were used, arc voltage of 32 V, arc current of 140 A, traverse speed of 1200 millimeters per second, stand off distance of 8 inches, atomizing air of 130 psi and cooling air of 90 psi. If copper is used to form the metal layer 134 then the only changes to the thermal spray parameters are to reduce the arc voltage to 29 V and to increase the current to 200 A. The thermal spray was passed over the lexan 130 for either 3 or 4 passes as noted. Several important findings emerge. First, the metal layer 134 is continuous, electrically conductive and has variable resistance. Second, the metal layer 134 only adhered to the powder particle 132 pathway and no where else on the lexan 130.

FIG. 8 is an example of the present invention using a nozzle as shown in FIG. 3. A lexan plastic material 140 was initially sprayed with tin powder particles 142. The kinetic spray parameters were as follows: a main gas pressure of 300 psi, powder particle gas pressure of 50 psi, main gas temperatures of 800° F., traverse speed of 100 millimeters per second, powder feed rate of 54 grams per minute, powder particle nominal average diameter of greater than 63 to 90 microns or 100 to 177 microns, and a stand off distance of 1 inch. The deposited tin powder particles 142 formed a discontinuous non-conducting pathway on the lexan 140 with defined edges. The twin wire arc thermal spray was used to deposit a metal layer 144 over the powder particles 132. The twin wire arc parameters were as follows: nickel chrome wires were used, arc voltage of 32 V, arc current of 140 A, traverse speed of 1200 millimeters per second, stand off distance of 8 inches, atomizing air of 130 psi and cooling air of 90 psi. If copper is used to form the metal layer 144 then the only changes to the thermal spray parameters are to reduce the arc voltage to 29 V and to increase the current to 200 A. The thermal spray was passed over the lexan 130 for either 3 or 4 passes as noted. Several important findings emerge. First, the metal layer 144 is continuous, electrically conductive and has variable resistance. Second, the metal layer 144 only adhered to the powder particle 142 pathway and no where else on the lexan 140.

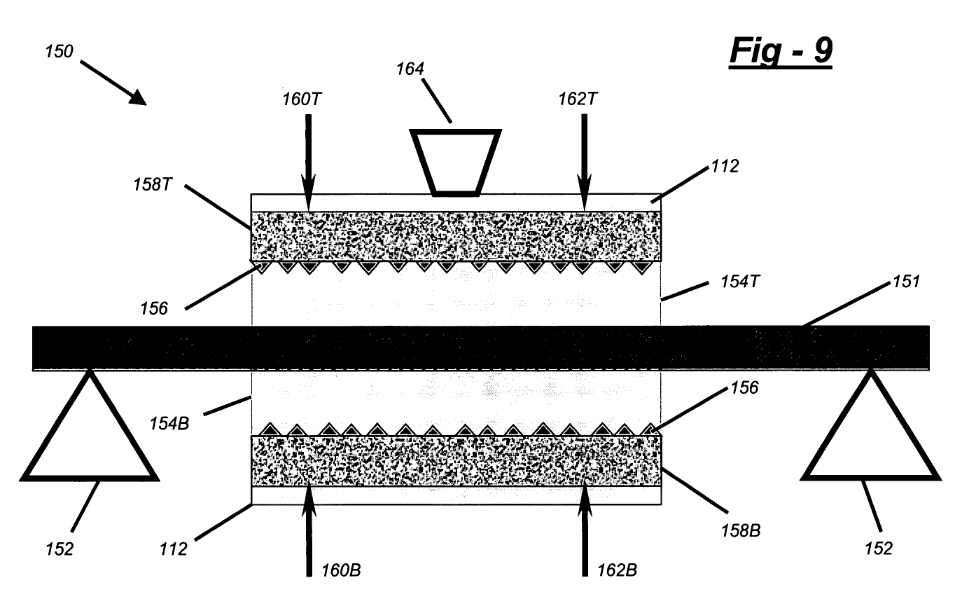

In FIG. 9a three point bend stress/strain device is shown generally at 150. A metal plate 151 is supported on two supports 152. A plastic plate 154B is attached with epoxy to a bottom side of the metal plate 151 and another plastic plate 154T is attached with epoxy to a top side of the metal plate 151. Powder particles 156 are applied in a discontinuous non-electrically conducting array by the kinetic spray process described above to each plastic plate 154B and 154T. A thermal spray process is been used to deposit a metal layer 158B and 158T over the powder particles 156 on the plates 154B and 154T respectively. A protective film 112 is applied to each metal layer 158B and 158T. An applied downward force 164 puts the top metal coating 158T in compression and the bottom metal coating 158B in tension. Spaced apart electrical probes 160T and 162T are place on the top metal layer 158T. Spaced apart electrical probes 160B and 162B are also placed on the bottom metal layer 158B. The electrical resistance or alternatively the electrical conductance between the two top probes 160T and 162T and the electrical resistance or alternatively the electrical conductance between the two bottom probes 160B and 162B are measured as the force 164 is applied. The force 164 introduces both stress and strain into the layers 158B and 158T.

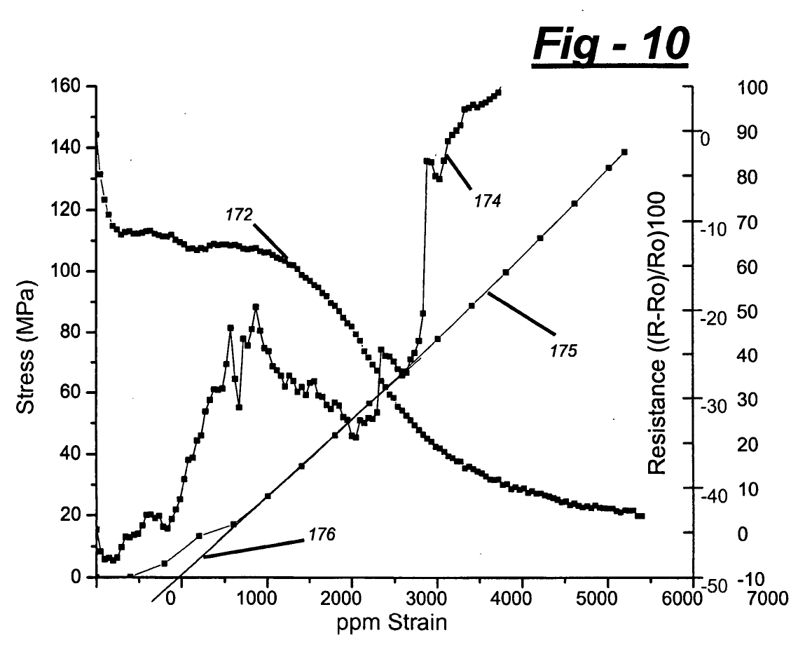

FIG. 10 is a graph of results obtained using the device 150 shown in FIG. 9. An aluminum plate had a lexan substrate epoxyed to its top and bottom sides. Each of the lexan substrates were kinetic spray coated with copper powder particles as described above. Then a metal layer of nickel chrome was deposited using a twin wire arc thermal spray process onto the powder particles. For each side the distance between the electrical probes was 70 millimeters. Reference line 172 shows the electrical resistance of the top metal layer, which is in compression, as the force was increased. The results show that as the applied force increased the electrical resistance decreased. Reference line 174 shows the electrical resistance of the bottom metal layer, which is in tension, as the force was increased. The results show that as the applied force increased the electrical resistance increased. Reference line 175 shows a plot of the measured strain while reference line 176 is a linear fit to the data shown in reference line 175.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

1. A method of forming a strain gauge on a surface comprising the steps of:
a) providing an electrically insulative layer on a surface, the surface comprising one of a ceramic surface, a metal surface, or a mixture thereof;
b) kinetically spraying a discontinuous non-electrically conductive pattern of powder particles onto the electrically insulative layer, the particles adhering to the insulative layer and a majority of the particles partially protruding there from; and
c) thermally spraying an electrically conductive metal layer having a variable resistance onto the pattern of powder particles, the metal layer only adhering to the powder particle pattern and the electrical resistance of the metal layer varying as a function of stress in the surface.

2. The method as recited in claim 1, wherein step a) comprises providing one of a plastic layer, an epoxy layer, or a thermal spray applied layer of alumina as the insulative layer.

3. The method as recited in claim 1, wherein step b) comprises kinetically spraying powder particles comprising a metal, an alloy, a ceramic, a diamond, or mixtures thereof.

4. The method as recited in claim 1, wherein step b) comprises kinetically spraying powder particles having an average nominal diameter of from greater than 50 microns to 177 microns.

5. The method as recited in claim 1, wherein step b) comprises kinetically spraying the powder particles at a main gas temperature of from 200 to 3000° F.

6. The method as recited in claim 1, wherein step b) comprises kinetically spraying the powder particles at a traverse rate of from 25 to 2500 millimeters per second.

7. The method as recited in claim 1, wherein step b) comprises kinetically spraying the powder particles using an offset distance from the insulative layer of from 0.5 to 12 inches.

8. The method as recited in claim 1, wherein step c) comprises thermally spraying the electrically conductive metal layer using a twin wire arc thermal spray process.

9. The method as recited in claim 8, wherein step c) comprises selecting one of a metal or an alloy as the metal layer.

10. The method as recited in claim 9 wherein step c) comprises selecting copper, a copper alloy, or a nickel and chromium containing alloy as the metal layer.

11. The method as recited in claim 1 wherein step a) further comprises providing the electrically insulative layer on one of a metal pipe, a metal conduit, a metal support structure, or a metal beam.

12. The method as recited in claim 1, further comprising a step d) after step c) of applying an outer protective layer over the thermally sprayed electrically conductive metal layer.

13. The method as recited in claim 1, further comprising after step c) the step of monitoring at least one of an electrical resistance of the electrically conductive metal layer or an electrical conductance of the electrically conductive metal layer to detect a change in the resistance or the conductance.

14. A method of forming a strain gauge on a plastic material surface comprising the steps of:
a) kinetically spraying a discontinuous non-electrically conductive pattern of powder particles onto a surface of a plastic material, the particles adhering to the surface and a majority of the particles partially protruding there from; and
b) thermally spraying an electrically conductive metal layer having a variable resistance onto the pattern of powder particles, the metal layer only adhering to the pattern of powder particles and the electrical resistance of the metal layer varying as a function of stress in the plastic material surface.

15. The method as recited in claim 14, wherein step a) comprises kinetically spraying powder particles comprising a metal, an alloy, a ceramic, a diamond, or mixtures thereof.

16. The method as recited in claim 14, wherein step a) comprises kinetically spraying powder particles having an average nominal diameter of from greater than 50 microns to 177 microns.

17. The method as recited in claim 14, wherein step a) comprises kinetically spraying the powder particles at a main gas temperature of from 200 to 3000° F.

18. The method as recited in claim 14, wherein step a) comprises kinetically spraying the powder particles at a traverse rate of from 25 to 2500 millimeters per second.

19. The method as recited in claim 14, wherein step a) comprises kinetically spraying the powder particles using an offset distance from the surface of the plastic material of from 0.5 to 12 inches.

20. The method as recited in claim 14, wherein step b) comprises thermally spraying the electrically conductive metal layer using a twin wire arc thermal spray process.

21. The method as recited in claim 20, wherein step b) comprises selecting one of a metal or an alloy as the metal layer.

22. The method as recited in claim 21 wherein step b) comprises selecting copper, a copper alloy, or a nickel and chromium containing alloy.

23. The method as recited in claim 14 wherein step a) further comprises applying the powder particles onto the surface of a plastic material comprising one of a pipe, a conduit, a support structure, a beam, a panel, or a formed plastic material object.

24. The method as recited in claim 14, further comprising a step c) after step b) of applying an outer protective layer over the thermally sprayed electrically conductive metal layer.

25. The method as recited in claim 14, further comprising after step b) the step of monitoring at least one of an electrical resistance of the electrically conductive metal layer or an electrical conductance of the electrically conductive metal layer to detect a change in the resistance or the conductance.

26. A method of forming strain gauge on a plastic material surface comprising the steps of:
a) applying a discontinuous non-electrically conductive pattern of powder particles onto a surface of a plastic material and applying a compressive force to the pattern of particles, the particles adhering to the surface and a majority of the particles partially protruding there from; and
b) thermally spraying an electrically conductive metal layer having a variable resistance onto the pattern of powder particles, the metal layer only adhering to the pattern of the powder particles and the electrical resistance of the metal layer varying as a function of stress in the plastic material surface.

27. The method as recited in claim 26, wherein step a) comprises applying a compressive force of from about 2000 to 5000 pounds.

28. The method as recited in claim 26, further comprising the step of heating the surface of the plastic material to a temperature sufficient to soften the surface prior to step a).

29. The method as recited in claim 26, wherein step b) comprises thermally spraying the electrically conductive metal layer using a twin wire arc thermal spray process.

30. The method as recited in claim 26, wherein step b) comprises selecting one of a metal or an alloy as the metal layer.

31. The method as recited in claim 30 wherein step b) comprises selecting copper, a copper alloy, or a nickel and chromium containing alloy.

32. The method as recited in claim 26 wherein step a) further comprises applying the powder particles onto the surface of a plastic material comprising one of a pipe, a conduit, a support structure, a beam, a panel, or a formed plastic material object.

33. The method as recited in claim 26, further comprising a step c) after step b) of applying an outer protective layer over the thermally sprayed electrically conductive metal layer.

34. The method as recited in claim 26, further comprising after step b) the step of monitoring at least one of an electrical resistance of the electrically conductive metal layer or an electrical conductance of the electrically conductive metal layer to detect a change in the resistance or the conductance.

35. A method of forming a high melting temperature layer on a plastic material surface comprising the steps of:
a) kinetically spraying a pattern of powder particles onto a surface of a plastic material, the particles adhering to the surface and a majority of the particles partially protruding there from; and
b) thermally spraying a high melting temperature material comprising at least one of a ceramic, a metal, an alloy, or a mixture thereof into a layer onto the pattern of powder particles, the layer only adhering to the pattern of powder particles on the plastic material surface and having a melting temperature of at least 400° F.

36. The method as recited in claim 35, wherein step a) comprises kinetically spraying powder particles comprising a metal, an alloy, a ceramic, a diamond, or mixtures thereof.

37. The method as recited in claim 35, wherein step a) comprises kinetically spraying powder particles having an average nominal diameter of from greater than 50 microns to 177 microns.

38. The method as recited in claim 35, wherein step a) comprises kinetically spraying the powder particles at a main gas temperature of from 200 to 3000° F.

39. The method as recited in claim 35, wherein step a) comprises kinetically spraying the powder particles at a traverse rate of from 25 to 2500 millimeters per second.

40. The method as recited in claim 35, wherein step a) comprises kinetically spraying the powder particles using an offset distance from the surface of the plastic material of from 0.5 to 12 inches.

41. The method as recited in claim 35, wherein step b) comprises thermally spraying the high melting temperature material using a twin wire arc thermal spray process.

42. The method as recited in claim 41, wherein step b) comprises selecting one of a metal or an alloy as the metal layer.

43. The method as recited in claim 41 wherein step b) comprises selecting copper, a copper alloy, or a nickel and chromium containing alloy.

44. A method of forming a high melting temperature metal layer on a plastic material surface comprising the steps of:
a) applying a pattern of powder particles onto a surface of a plastic material and applying a compressive force to the pattern of particles, the particles adhering to the surface and a majority of the particles partially protruding there from; and
b) thermally spraying a high melting temperature metal layer onto the pattern of powder particles, the metal layer only adhering to the pattern of powder particles in the plastic material surface and having a melting temperature of at least 400° F.

45. The method as recited in claim 44, wherein step a) comprises applying a compressive force of from about 2000 to 5000 pounds.

46. The method as recited in claim 44, further comprising the step of heating the surface of the plastic material to a temperature sufficient to soften the surface prior to step a).

47. The method as recited in claim 44, wherein step b) comprises thermally spraying the electrically conductive metal layer using a twin wire arc thermal spray process.

48. The method as recited in claim 44, wherein step b) comprises selecting one of a metal or an alloy as the metal layer.

49. The method as recited in claim 48 wherein step b) comprises selecting copper, a copper alloy, or a nickel and chromium containing alloy.

50. A method of forming a long length strain gauge comprising the steps of:
a) providing an electrically insulative layer on a surface, the surface comprising one of a ceramic surface, a metal surface, or a mixture thereof;
b) kinetically spraying a continuous, electrically conductive layer of powder particles onto the electrically insulative layer, the particles adhering to the insulative layer and a majority of the particles partially protruding there from and the electrical resistance of the powder particles layer varying as a function of stress in the surface.

51. The method as recited in claim 50, wherein step a) comprises providing one of a plastic layer, an epoxy layer, or a thermal spray applied layer of alumina as the insulative layer.

52. The method as recited in claim 50, wherein step b) comprises kinetically spraying powder particles comprising a metal, an alloy, or mixtures thereof.

53. The method as recited in claim 50, wherein step b) comprises kinetically spraying powder particles having an average nominal diameter of from greater than 50 microns to 177 microns.

54. The method as recited in claim 50, wherein step b) comprises kinetically spraying the powder particles at a main gas temperature of from 200 to 3000° F.

55. The method as recited in claim 50, wherein step b) comprises kinetically spraying the powder particles at a traverse rate of from 25 to 2500 millimeters per second.

56. The method as recited in claim 50, wherein step b) comprises kinetically spraying the powder particles using an offset distance from the insulative layer of from 0.5 to 12 inches.

57. The method as recited in claim 50, further comprising after step b) the step of monitoring at least one of an electrical resistance of the electrically conductive metal layer or an electrical conductance of the electrically conductive metal layer to detect a change in the resistance or the conductance.

58. A method of forming a strain gauge on a plastic material surface comprising the steps of:
a) kinetically spraying a continuous electrically conductive pattern of powder particles onto a surface of a plastic material, the particles adhering to the surface and a majority of the particles partially protruding there from and the electrical resistance of the powder particles layer varying as a function of stress in the plastic material surface.

59. The method as recited in claim 58, wherein step a) comprises kinetically spraying powder particles comprising a metal, an alloy, or mixtures thereof.

60. The method as recited in claim 58, wherein step a) comprises kinetically spraying powder particles having an average nominal diameter of from greater than 50 microns to 177 microns.

61. The method as recited in claim 58, wherein step a) comprises kinetically spraying the powder particles at a main gas temperature of from 200 to 3000° F.

62. The method as recited in claim 58, wherein step a) comprises kinetically spraying the powder particles at a traverse rate of from 25 to 2500 millimeters per second.

63. The method as recited in claim 58, wherein step a) comprises kinetically spraying the powder particles using an offset distance from the surface of the plastic material of from 0.5 to 12 inches.
